(19) United States
(12) Patent Application Publication
(10) Pub. No.: US 2020/0230781 A1
(43) Pub. Date: Jul. 23, 2020

(54) POLISHING PADS FORMED USING AN ADDITIVE MANUFACTURING PROCESS AND METHODS RELATED THERETO

(71) Applicant: Applied Materials, Inc., Santa Clara, CA (US)

(72) Inventors: Ashwin CHOCKALINGAM, Santa Clara, CA (US); Jason G. FUNG, Santa Clara, CA (US); Sivapackia GANAPATHIAPPAN, Los Altos, CA (US); Rajeev BAJAJ, Fremont, CA (US); Daniel REDFIELD, Morgan Hill, CA (US)

(21) Appl. No.: 16/291,647

(22) Filed: Mar. 4, 2019

Related U.S. Application Data
(60) Provisional application No. 62/795,642, filed on Jan. 23, 2019.

(51) Int. Cl. B24B 37/26; B33Y 10/00; B33Y 30/00; B33Y 50/02; B33Y 80/00; B29C 64/112; B29C 64/393; B33Y 70/00

(52) U.S. Cl. CPC B24B 37/26; B33Y 10/00; B33Y 30/00; B33Y 50/02; B29L 2031/736; B29C 64/112; B29C 64/393; B33Y 70/00; B33Y 80/00

(57) ABSTRACT

Embodiments of the present disclosure generally relate to polishing pads, and methods for manufacturing polishing pads, which may be used in a chemical mechanical polishing (CMP) process in the manufacture of semiconductor devices. The polishing pads described herein feature a continuous polymer phase of polishing pad material comprising one or more first material domains and a plurality of second material domains. The one or more first material domains are formed of a polymerized reaction product of a first pre-polymer composition, the plurality of second material domains are formed of a polymerized reaction product of a second pre-polymer composition, the second pre-polymer composition is different from the first pre-polymer composition, and interfacial regions between the one or more first material domains and the plurality of second material are formed of a co-polymerized reaction product of the first pre-polymer composition and the second pre-polymer composition.

### CROSS-REFERENCE TO RELATED APPLICATIONS

This application claims priority to U.S. Provisional Application Ser. No. 62/795,642, filed on Jan. 23, 2019, which is herein incorporated by reference in its entirety.

### BACKGROUND

### Field

Embodiments of the present disclosure generally relate to polishing pads, and methods of manufacturing polishing pads, and more particularly, to polishing pads used for chemical mechanical polishing (CMP) of a substrate in an electronic device fabrication process.

### Description of the Related Art

Chemical mechanical polishing (CMP) is commonly used in the manufacturing of high-density integrated circuits to planarize or polish a layer of material deposited on a substrate. A typical CMP process includes contacting the material layer to be planarized with a polishing pad and moving the polishing pad, the substrate, or both, and hence creating relative movement between the material layer surface and the polishing pad, in the presence of a polishing fluid comprising abrasive particles. One common application of CMP in semiconductor device manufacturing is planarization of a bulk film, for example pre-metal dielectric (PMD) or interlayer dielectric (ILD) polishing, where underlying two or three dimensional features create recesses and protrusions in the surface of the layer to be planarized. Other common applications of CMP in semiconductor device manufacturing include shallow trench isolation (STI) and interlayer metal interconnect formation, where CMP is used to remove the via, contact or trench fill material from the exposed surface (field) of the layer having the STI or metal interconnect features disposed therein.

In a typical CMP process, a substrate is retained in a carrier head that presses the backside of the substrate towards the polishing pad. Material is removed across the material layer surface in contact with the polishing pad through a combination of chemical and mechanical activity which is provided by the polishing fluid and the abrasive particles. Typically, the abrasive particles are either suspended in the polishing fluid, known as a slurry, or are embedded in the polishing pad, known as a fixed abrasive polishing pad.

Often the polishing pad is selected based on the material properties thereof and the suitability of those material properties for a desired CMP application. For example, polishing pads formed of comparatively harder materials (hard polishing pads) generally provide superior localized planarization performance, provide a desirably higher material removal rate for dielectric films used for PMD, ILD, and STI, and cause less undesirable dishing of the upper surface of the film material in recessed features, such as trenches, contacts, and lines. Polishing pads formed of comparatively softer materials (soft polishing pads) generally have a relativity lower material removal rate, provide more stable substrate to substrate material removal rates across the polishing pad lifetime, cause less undesirable erosion of a planer surface in areas with high feature density, and provide a relativity superior surface finish, e.g., by causing cause fewer micro-scratches of or in the material surface of the substrate.

Unfortunately, attempts to conventionally manufacture, e.g., casting or molding, polishing pads which incorporate both hard and soft polishing pad materials generally result in polishing pads lacking the desired characteristics of either hard or soft pads.

Accordingly, there is a need in the art for polishing pads and methods of manufacturing polishing pads which comprise more than one material property in the polishing pad material thereof.

### SUMMARY

Embodiments of the present disclosure generally relate to polishing pads, and methods for manufacturing polishing pads, which may be used in a chemical mechanical polishing (CMP) process.

In one embodiment a polishing pad features a continuous polymer phase of polishing pad material which forms a polishing surface of the polishing pad. The continuous polymer phase of comprises one or more first material domains and a plurality of second material domains. Here, the one or more first material domains are formed of a polymerized reaction product of a first pre-polymer composition, the plurality of second material domains are formed of a polymerized reaction product of a second pre-polymer composition, the second pre-polymer composition is different from the first pre-polymer composition, and interfacial regions between the one or more first material domains and the plurality of second material are formed of a co-polymerized reaction product of the first pre-polymer composition and the second pre-polymer composition. The plurality of second material domains are distributed in a pattern across an X-Y plane of the polishing pad in a side by side arrangement with the one or more first material domains, the X-Y plane is parallel to a supporting surface of the polishing pad, the one or more first material domains and the plurality of second material domains comprise a difference in one or more material properties from one another, and at least one dimension of one or more of the second material domains is less than about 10 mm when measured in the X-Y plane.

In another embodiment a method of forming a polishing pad includes sequential repetitions of: dispensing droplets of a first pre-polymer composition and droplets of a second pre-polymer composition onto a surface of a previously formed print layer according to a predetermined droplet dispense pattern and at least partially curing the dispensed droplets of the first pre-polymer composition and the dispensed droplets of the second pre-polymer composition to form a print layer comprising at least portions of one or more first material domains and a plurality of second material domains. Here, the first pre-polymer composition is different from the second pre-polymer composition, at least partially curing the dispensed droplets at least partially co-polymerizes the first pre-polymer composition and the second pre-polymer composition at interfacial boundary regions disposed at adjoining locations of the different material domains to form a continuous polymer phase of polishing material, the plurality of second material domains are distributed in a pattern across an X-Y plane parallel to a supporting surface of the polishing pad and are disposed in a side by side arrangement with the one or more first material domains, the one or more first material domains and the second material domains comprise a difference in one or more material properties from one another, and at least one dimension of one or more of the second material domains is less than about 10 mm when measured in the X-Y plane.

In another embodiment a computer readable medium having instructions stored thereon for performing a method of manufacturing a polishing pad when executed by a system controller is provided. The method includes sequential repetitions of: dispensing droplets of a first pre-polymer composition and droplets of a second pre-polymer composition onto a surface of a previously formed print layer according to a predetermined droplet dispense pattern and at least partially curing the dispensed droplets of the first pre-polymer composition and the dispensed droplets of the second pre-polymer composition to form a print layer comprising at least portions of one or more first material domains and a plurality of second material domains. Here, the first pre-polymer composition is different from the second pre-polymer composition, at least partially curing the dispensed droplets at least partially co-polymerizes the first pre-polymer composition and the second pre-polymer composition at interfacial boundary regions at adjoining locations of the different material domains to form a continuous polymer phase of polishing material, the plurality of second material domains are distributed in a pattern across an X-Y plane parallel to a supporting surface of the polishing pad and are disposed in a side by side arrangement with the one or more first material domains, the one or more first material domains and the second material domains comprise a difference in one or more material properties from one another, and at least one dimension of one or more of the second material domains is less than about 10 mm when measured in the X-Y plane.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic side view of an exemplary polishing system configured to use a polishing pad formed according to one or more, or a combination of, the embodiments described herein.

FIGS. 2A-2B are schematic perspective sectional views of polishing pads formed according to one or more, or a combination of, the embodiments described herein.

FIG. 3A is a schematic close-up top down view a portion of a polishing surface of the polishing pad described in FIG. 2A.

FIG. 3B is a schematic cross-sectional view of a portion of a polishing pad taken along line 3B-3B of FIG. 3A, according to one or more, or a combination of, the embodiments described herein.

FIG. 3C schematic close-up top down view of a portion of a polishing pad surface, such as the polishing pad described in FIGS. 2A-2B, according to one or more, or a combination of, the embodiments described herein.

FIG. 3D is a schematic cross-sectional view of a portion of a polishing pad taken along line 3D-3D of FIG. 3C, according to one or more, or a combination of, the embodiments described herein.

FIGS. 3E and 3F are schematic close-up top down views of a portion of a polishing pad surface, such as the polishing pad described in FIGS. 2A-2B, according to one or more, or a combination of, the embodiments described herein.

FIG. 4A is a schematic sectional view of an additive manufacturing system which may be used to manufacture polishing pads according to one or more, or a combination of, the embodiments described herein.

FIG. 4B is a close-up cross-sectional view schematically illustrating a droplet disposed on a surface of a previously formed print layer, according to one or more, or a combination of, the embodiments described herein.

FIGS. 5A and 5B schematically illustrate droplet dispensing instructions which may be used by an additive manufacturing system to form a print layer of a polishing pad according to one or more, or a combination of, the embodiments described herein.

FIG. 6 is a flow diagram setting forth a method of forming the polishing pads described herein, according to one or more, or a combination of, the embodiments described herein.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments described herein generally relate to polishing pads, and methods for manufacturing polishing pads which may be used in a chemical mechanical polishing (CMP) process. In particular, the polishing pads described herein feature spatially arranged material domains which together form a continuous polymer phase of polishing material.

The term “spatially arranged material domains” as used herein refers to the distribution of material domains, respectively formed from at least two different pre-polymer compositions, in the polishing material of the polishing pad. Herein, the different material domains are distributed, with respect to one another, in one or both directions of an X-Y plane parallel to a polishing surface of the polishing pad (i.e., laterally) and in a z-direction which is orthogonal to the X-Y planes, i.e., vertically. At least portions of material domains formed from the same pre-polymer composition are spatially separated, i.e., spaced apart from one another, by at least portions of material domains formed from a different precursor composition interposed therebetween. The at least two different pre-polymer compositions are at least partially polymerized upon at least partial curing thereof to prevent or limit intermixing of the materials of the domains and thereby form the different material domains which comprise differences in one or more material properties from one another adjacent to, and in contact with, each other.

The continuous polymer phase described herein is formed by the at least partial polymerization of the different pre-polymer compositions respectively and by at least partial copolymerization of different pre-polymer compositions at interfacial boundary regions disposed at the adjoining locations of the different material domains, i.e., the interfacial boundary regions thereof. Herein, the at least two different pre-polymer compositions include different monomer or oligomer species from one another and the interfacial boundary regions disposed at the adjoining locations between the different material domains feature the different monomer or oligomer species linked by covalent bonds to form a copolymer thereof. In some embodiments, the copolymer formed at the interfacial boundary regions comprise one or a combination of block copolymers, alternating copolymers, periodic copolymers, random copolymers, gradient copolymers, branched copolymers, graft copolymers, and combinations thereof.

Although embodiments described herein are generally related to chemical mechanical polishing (CMP) pads used in semiconductor device manufacturing, the polishing pads and manufacturing methods thereof are also applicable to other polishing processes using both chemically active and chemically inactive polishing fluids and/or polishing fluids free from abrasive particles. In addition, embodiments described herein, alone or in combination, may be used in at least the following industries: aerospace, ceramics, hard disk drive (HDD), MEMS and Nano-Tech, metalworking, optics and electro-optics manufacturing, and semiconductor device manufacturing, among others.

Generally, the methods set forth herein use an additive manufacturing system, e.g., a 2D or a 3D inkjet printer system, to form (print) at least portions of the polishing pads in a layer-by-layer process. Typically, each print layer is formed (printed) by sequentially depositing and at least partially curing respective droplets of at least two different pre-polymer compositions on a manufacturing support or a previously formed print layer. Beneficially, the additive manufacturing system and the methods set forth herein enable at least micron scale droplet placement control within each print layer (XY resolution) as well as micron scale (0.1 μm to 200 μm) control over the thickness (Z resolution) of each print layer. The micron scale XY and Z resolutions provided by the additive manufacturing systems and the methods set forth herein facilitate the formation of desired and repeatable patterns of the at least two, i.e., two or more, different, material domains, each having unique properties and attributes. Thus, in some embodiments, the methods of forming polishing pads which are set forth herein also impart one or more distinctive structural characteristics of the polishing pads formed therefrom.

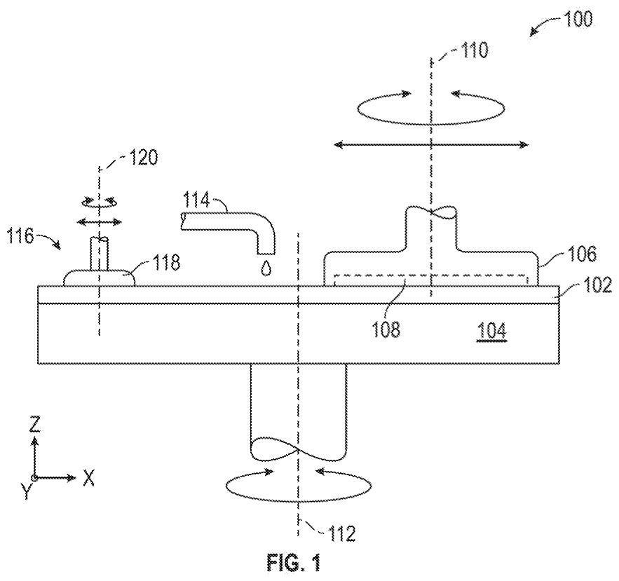

FIG. 1 is a schematic side view of an example polishing system configured to use a polishing pad formed according to one or a combination of embodiments described herein. Here, the polishing system 100 features a platen 104, having a polishing pad 102 secured thereto using a pressure sensitive adhesive, and a substrate carrier 106. The substrate carrier 106 faces the platen 104 and the polishing pad 102 mounted thereon. The substrate carrier 106 is used to urge a material surface of a substrate 108, disposed therein, against the polishing surface of the polishing pad 102 while simultaneously rotating about a carrier axis 110. Typically, the platen 104 rotates about a platen axis 112 while the rotating substrate carrier 106 sweeps back and forth from an inner diameter to an outer diameter of the platen 104 to, in part, reduce uneven wear of the polishing pad 102.

The polishing system 100 further includes a fluid delivery arm 114 and a pad conditioner assembly 116. The fluid delivery arm 114 is positioned over the polishing pad 102 and is used to deliver a polishing fluid, such as a polishing slurry having abrasives suspended therein, to a surface of the polishing pad 102. Typically, the polishing fluid contains a pH adjuster and other chemically active components, such as an oxidizing agent, to enable chemical mechanical polishing of the material surface of the substrate 108. The pad conditioner assembly 116 is used to condition the polishing pad 102 by urging a fixed abrasive conditioning disk 118 against the surface of the polishing pad 102 before, after, or during polishing of the substrate 108. Urging the conditioning disk 118 against the polishing pad 102 includes rotating the conditioning disk 118 about an axis 120 and sweeping the conditioning disk 118 from an inner diameter the platen 104 to an outer diameter of the platen 104. The conditioning disk 118 is used to abrade, rejuvenate, and remove polish byproducts or other debris from, the polishing surface of the polishing pad 102.

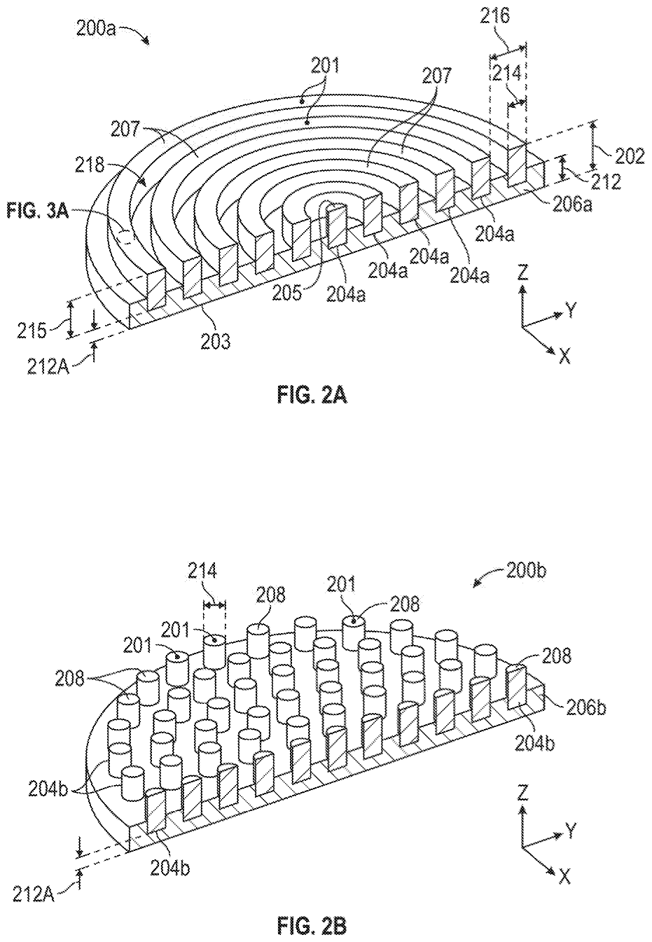

FIGS. 2A-2B are schematic perspective sectional views of various polishing pads 200a-b which are formed according to one or a combination of the methods set forth herein. The polishing pads 200a-b can be used as the polishing pad 102 of the exemplary polishing system 100 described in FIG. 1.

In FIG. 2A, the polishing pad 200a comprises a plurality of polishing elements 204a which are partially disposed within a sub-polishing element 206a and extend from a surface of the sub-polishing element 206a. The polishing pad 200a has a thickness 202, the plurality of polishing elements 204a have a sub-thickness 215 and the sub-polishing element 206a has a sub-thickness 212. The polishing elements 204a are supported in the thickness direction of the pad 200a by a portion of the sub-polishing element 206a (e.g., portion within region 212A). Therefore, when a load is applied to the polishing surface 201 of the polishing pads 200a (i.e., the top surface) by a substrate during processing, the load will be transmitted through the polishing elements 204a and portion 212A of the sub-polishing element 206a. Here, the plurality of polishing elements 204a include a plurality of concentric rings 207 disposed about a post 205 and extending radially outward therefrom. Here, the post 205 is disposed in the center of the polishing pad 200a. In other embodiments the center of the post 205, and thus the center of the concentric rings 207, may be offset from the center of the polishing pad 200a to provide a wiping type relative motion between a substrate and the polishing pad surface as the polishing pad rotates on a polishing platen.

The plurality of polishing elements 204a and the sub-polishing element 206a define a plurality of channels 218 disposed in the polishing pad 200a between each of the polishing elements 204a and between a plane of the polishing surface of the polishing pad 200a and a surface of the sub-polishing element 206a. The plurality of channels 218 enable the distribution of polishing fluids across the polishing pad 200a and to an interface between the polishing pad 200a and the material surface of a substrate to be polished thereon. In other embodiments, the patterns of the circumferential polishing elements 204a are rectangular, spiral, fractal, random, another pattern, or combinations thereof in circumference. Here, a width 214 of the polishing element(s) 204a is between about 250 microns and about 5 millimeters, such as between about 250 microns and about 2 millimeters. A pitch 216 between the polishing element(s) 204a is between about 0.5 millimeters and about 5 millimeters. In some embodiments, one or both of the width 214 and the pitch 216 vary across a radius of the polishing pad 200a to define zones of pad material properties.

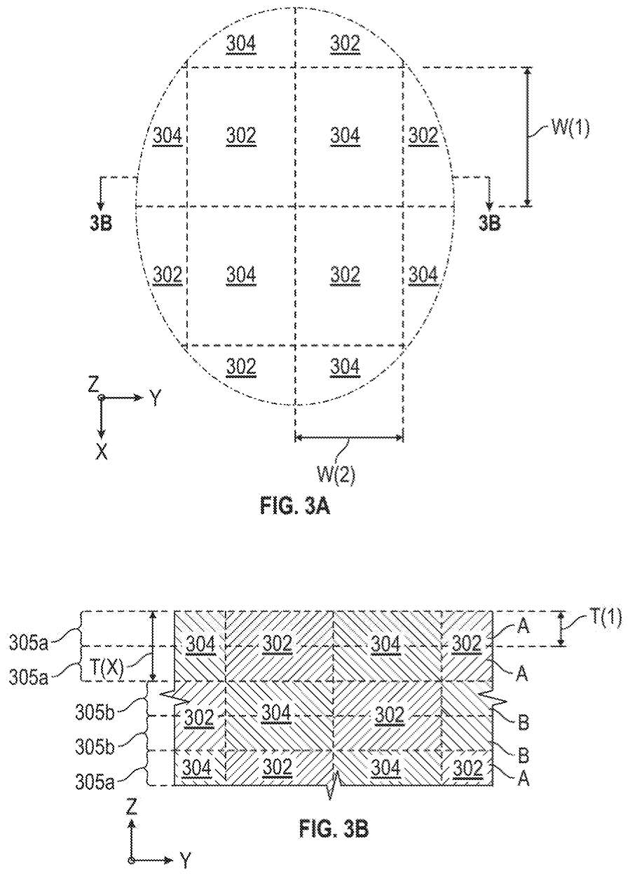

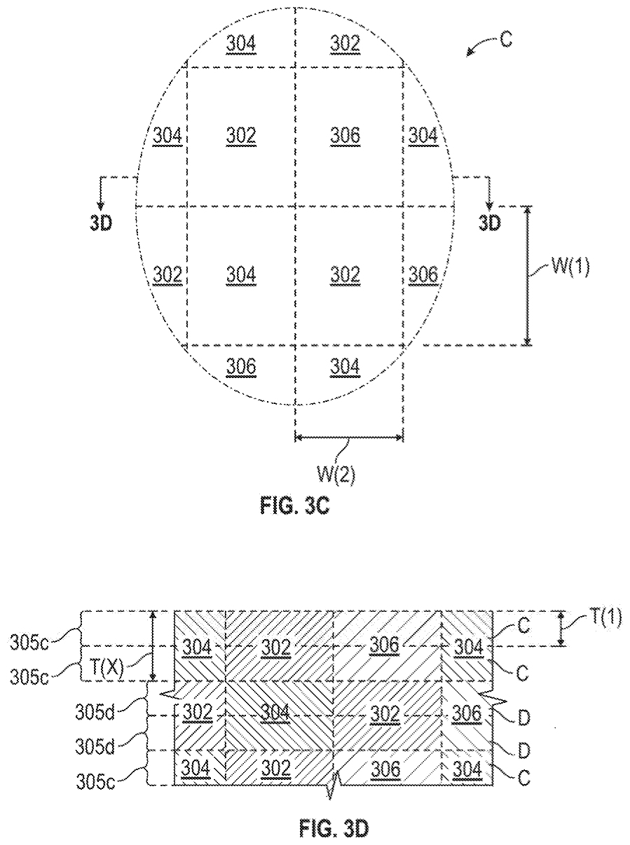

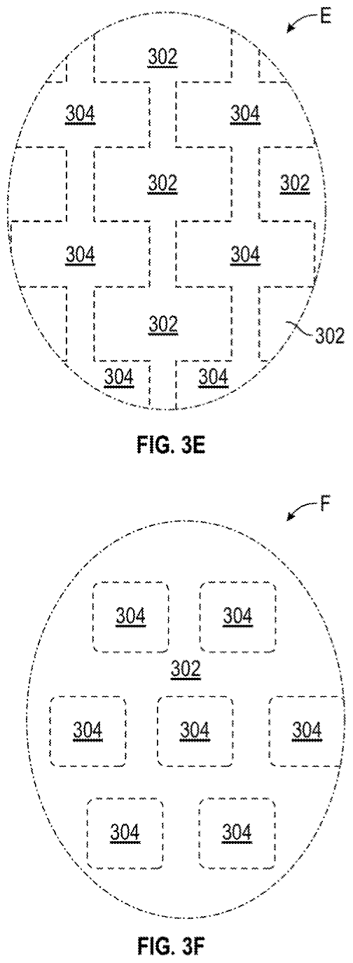

In FIG. 2B, the polishing elements 204b are shown as circular columns extending from the sub-polishing element 206b. In other embodiments, the polishing elements 204a are of any suitable cross-sectional shape, for example columns with toroidal, partial toroidal (e.g., arc), oval, square, rectangular, triangular, polygonal, irregular shapes in a section cut generally parallel to the underside surface of the pad 200b, or combinations thereof. In some embodiments, the shapes and widths 214 of the polishing elements 204b, and the distances therebetween, are varied across the polishing pad 200c to tune hardness, mechanical strength, fluid transport characteristics, or other desirable properties of the complete polishing pad 200b. In embodiments herein, one or both of the polishing elements 204a,b or the sub-polishing elements 206a,b are formed of a continuous polymer phase of polishing material which features pluralities of spatially arranged material domains, such as shown in FIGS. 3A-3D.

FIG. 3A is a schematic close-up top view of a portion of the polishing surface 201 of the polishing pad 200a described in FIG. 2A, according to one embodiment. FIG. 3B is a schematic sectional view of the portion of the polishing element 204a shown in FIG. 3A taken along the line 3B-3B. The portion of the polishing pad shown in FIGS. 3A-3B features a continuous polymer phase of polishing pad material formed of a plurality of spatially arranged first material domains 302 and a plurality of spatially arranged second material domains 304. Here, the spatially arranged second material domains 304 are interposed between the first material domains 302 and, in some embodiments, positioned adjacent thereto.

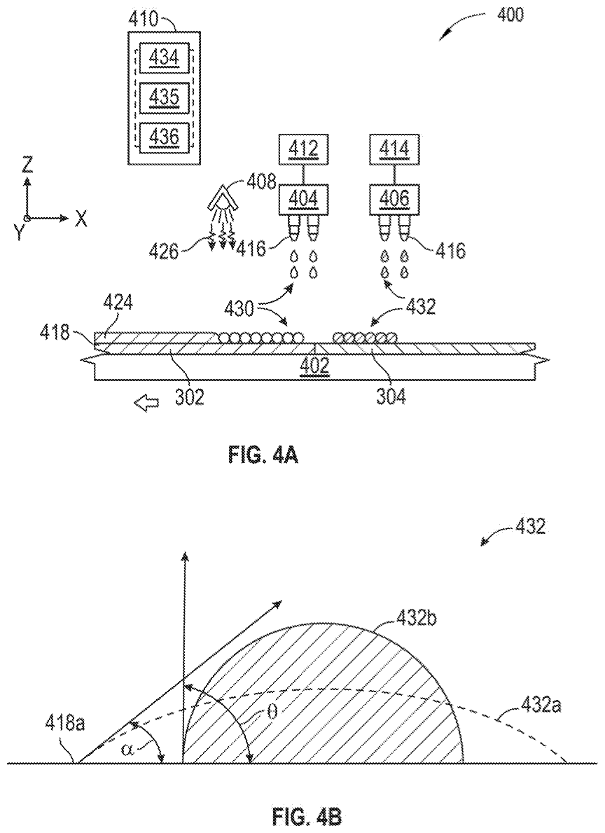

Typically, the first material domains 302 and the second material domains 304 are formed of different pre-polymer compositions, such as the example pre-polymer compositions set forth in the description of FIG. 4A, and thus comprise a difference from one another in one or more material properties. For example, in some embodiments, the storage modulus E′ of the first material domains 302 and the second material domains 304 are different from one another and the difference may be measured using a suitable measurement method, such as nanoindentation. In some embodiments, the plurality of second material domains 304 have a relativity low or relativity medium storage modulus E′ and the one or more first material domains 302 have a relatively medium or relativity high storage modulus E′. Characterizations as a low, medium, or high storage modulus E′ material domains at a temperatures of about 30° C. (E′30) are summarized in Table 1.

TABLE 1

| | Low Storage | | |
|---|---|---|---|
| | Modulus | Medium Modulus | High Modulus |
| | Compositions | Compositions | Compositions |
| E′30 | <100 MPa, (e.g., | 100 MPa-500 MPa | >500 MPa (e.g., |
| | 1 MPa-100 MPa) | | 500 MPa-3000 MPa) |

In some embodiments, a ratio of the storage modulus E′30 between either the first material domains 302 and the second material domains 304 or the second material domains 304 and the first material domains 302 is more than about 1:2, more than about 1:5, more than about 1:10, more than about 1:50, for example more than about 1:100. In some embodiments, the ratio of the storage modulus E′30 between the first material domain 302 and the second material domain 304 is more than about 1:500, for example more than 1:1000.

In FIG. 3A, the first and second material domains 302, 304 are arranged in a first pattern A which is used to form the polishing surface of the polishing pad in the X-Y plane of the X and Y directions. As shown, the first and second material domains 302, 304 have a rectangular sectional shape when viewed from above with a first lateral dimension W(1) and a second lateral dimension W(2). The lateral dimensions W(1) and W(2) are measured parallel to the polishing surface, and thus parallel to the supporting surface, of the polishing pad, i.e., in an XY plane. In other embodiments, the material domains which form the continuous polymer phase polishing pad material may have any desired sectional shape when viewed from above, including irregular shapes.

In some embodiments, at least one lateral dimension (i.e., measured in the X-Y plane of the X and Y directions) of one or both of the first or second material domains 302, 304 are less than about 10 mm, such as less than about 5 mm, less than about 1 mm, less than about 500 μm, less than about 300 μm, less than about 200 μm, less than about 150 μm, or between about 1 μm and about 150 μm. In some embodiments, the at least one lateral dimension W(1), W(2) is more than about 1 μm, such as more than about 2.5 μm, more than about 5 μm, more than about 7 μm, more than about 10 μm, more than about 20 μm, more than about 30 μm, for example more than about 40 μm.

In some embodiments, one or more lateral dimensions of the first and second material domains 302, 304 are varied across the polishing pad to tune the hardness, mechanical strength, fluid transport characteristics, or other desirable properties thereof. In the first pattern A the first and second material domains 302, 304 are distributed in a side by side arrangement parallel to an X-Y plane. Here, individual ones of the plurality of first material domains 302 are spaced apart by individual ones of the plurality of second material domains 304 interposed therebetween. In some embodiments, individual ones of the first or second material domains 302, 304 do not have a lateral dimension exceeding about 10 mm, exceeding about 5 mm, exceeding about 1 mm, exceeding about 500 μm, exceeding about 300 μm, exceeding about 200 μm, or exceeding about 150 μm.

Herein, the continuous polymer phase of polishing material is formed of a plurality of sequentially deposited and partially cured material precursor layers (print layers), such as the first print layers 305a and second print layers 305b shown in FIG. 3B. As shown the first and second material domains 302 and 304 are spatially arranged laterally across each of the first and second print layers 305a,b in a first pattern A or a second pattern B respectively. Each of the print layers 305a,b are sequentially deposited and at least partially cured to form a continuous polymer phase of polishing material with the one or more print layers 305a,b disposed adjacent thereto. For example, when at least partially cured each of the print layers 305a,b form a continuous polymer phase with one or both of a previously or subsequently deposited and at least partially cured print layers 305a,b disposed there below or there above.

Typically, each of the print layers 305a,b are deposited to a layer thickness T(1). The first and second material domains 302, 304 are formed of one or more sequentially formed layers 305a,b and a thickness T(X) of each material domain 302, 304 is typically a multiple, e.g., 1X or more, of the layer thickness T(1).

In some embodiments, the layer thickness T(1) is less than about 200 μm, such as less than about 100 μm, less than about 50 μm, less than about 10 μm, for example less than about 5 μm. In some embodiments, one or more of the material layers 305a,b is deposited to a layer thickness T(1) of between about 0.5 μm and about 200 μm, such as between about 1 μm and about 100 μm, between about 1 μm and about 50 μm, between about 1 μm and about 10 μm, or for example between about 1 μm and about 5 μm.

In some embodiments, the first material domains 302 and the second material domains 304 are alternately stacked one over the other in the Z-direction. For example, in some embodiments the plurality of the second material domains 304 are distributed in a pattern in a Z plane of the polishing pad in a stacked arrangement with one or more or a plurality of first material domains 302. In some of those embodiments, a thickness T(X) of one or more of the material domains 302, 304 is less than about than about 10 mm, such as less than about 5 mm, less than about 1 mm, less than about 500 μm, less than about 300 μm, less than about 200 μm, less than about 150 μm, less than about 100 μm, less than 50 μm, less than about 25 μm, less than about 10 μm, or between about 1 μm and about 150 μm. In some embodiments, the thickness T(X) of one or more of the material domains is more than about 1 μm, such as more than about 2.5 μm, more than about 5 μm, more than about 7 μm, or more than about 10 μm. In some embodiments, one or more of the material domains 302, 304 extend from the supporting surface of the polishing pad to the polishing surface and thus the thickness T(X) of the material domain may be the same as the thickness of the polishing pad. In some embodiments, one or more of the material domains 302, 304 extend a thickness of a polishing element or a sub-polishing elements, such as polishing elements and sub-polishing elements described in FIGS. 2A-2B.

In some embodiments, the polishing pad material further includes a plurality of pore forming features interspersed within the continuous polymer phase of the polishing material. Typically, the plurality of pore forming features are formed of a water soluble sacrificial material which dissolves upon exposure to a polishing fluid thus forming a corresponding plurality of pores in the polishing pad surface. In some embodiments, the water soluble sacrificial material will swell upon exposure to the polishing fluid thus deforming the surrounding polishing material to provide asperities at the polishing pad material surface. The resulting pores and asperities desirably facilitate transporting liquid and abrasives to the interface between the polishing pad and a to be polished material surface of a substrate, and temporarily fixing those abrasives (abrasive capture) in relation to the substrate surface to enable chemical and mechanical material removal therefrom. Examples of polishing pad materials further comprising spatially arranged pore forming features are set forth in the description of FIGS. 3C-3D.

FIG. 3C is a schematic close-up top view of a portion of a polishing pad material surface featuring a plurality of spatially arranged pore forming features, according to some embodiments. FIG. 3D is a schematic sectional view of the portion of polishing pad shown in FIG. 3C taken along the line 3D-3D. Here, a continuous polymer phase of polishing material is formed of a plurality of sequentially deposited and partially cured materiel precursor layers (print layers), such as the third print layers 305c or the fourth print layers 305d shown in FIG. 3D. As shown, the plurality of first and second material domains 302, 304 are disposed in a side by side arrangement parallel to the X-Y plane and the plurality of pore forming features 306 are interspersed within each of the third and fourth print layers 305c,d in a third pattern C or a forth pattern D respectively across the span of the print layer. The first and second material domains 302, 304 form a continuous polymer phase of polishing material and the discontinuous plurality of pore forming features 306 are interspersed between individual ones of the pluralities of spatially arranged material domains 302, 304.

FIGS. 3E and 3F are schematic close-up top views of a portion of the polishing surface 201 of the polishing pad 200a described in FIG. 2A, according to other embodiments. In FIG. 3E the first and second material domains 302, 304 are arranged in an interdigitated pattern E which is used to form the polishing surface of the polishing pad in the X-Y plane of the X and Y directions. Here, at least portions of the first material domains 302 are spaced apart from one another by at least portions of the second material domains 304 interposed therebetween. In FIG. 3F a plurality of second material domains 304 are arranged in an array pattern F and are spaced apart by portions of one or more continuous first material domains 302 interposed there between.

The additive manufacturing systems and the related polishing pad manufacturing methods set forth herein facilitate the formation of pore forming features, and thus the resulting pores and asperities, of any desired size or in any desired spatial arrangement. For example, in some embodiments the plurality of pore forming features 306 have one or more lateral (X-Y) dimensions which are less than about 10 mm, such as less than about 5 mm, less than about 1 mm, less than about 500 μm, less than about 300 μm, less than about 200 μm, less than about 150 μm, less than about 100 μm, less than about 50 μm, less than about 25 μm, or for example less than about 10 μm. In some embodiments, the one or more lateral dimension of the pore forming features 306 are more than about 1 μm, such as more than about 2.5 μm, more than about 5 μm, more than about 7 μm, more than about 10 μm, or more than about 25 μm. In some embodiments, the one or more lateral dimensions of the pore forming features 306 are varied across the polishing pad to tune the fluid transport characteristics or other desirable properties thereof.

Here, the pore forming features 306 have a thickness, such as the thickness T(X), which is typically a multiple, e.g., 1X or more, of a thickness T(1) of the each of the print layers 305c,d. For example, the thickness of the pore forming features within a print layer is typically the same as the thickness of the continuous polymer phase of polishing material disposed adjacent thereto. Thus, if the pore forming features laterally disposed within at least two sequentially deposited print layers are aligned or at least partially overlap in the Z-direction the thickness T(X) of the resulting pore forming feature will be at least the combined thickness of the at least two sequentially deposited print layers. In some embodiments, one or more of the pore forming features do not overlap with a pore forming feature in adjacent layer disposed there above or there below and thus has a thickness T(1). An exemplary additive manufacturing system which may be used to practice any one or a combination of the polishing pad manufacturing methods set forth herein is further described in FIG. 4A.

FIG. 4A is a schematic sectional view of an additive manufacturing system which may be used to form the polishing pads described herein, according to some embodiments. Here, the additive manufacturing system 400 features a movable manufacturing support 402, a plurality of dispense heads 404 and 406 disposed above the manufacturing support 402, a curing source 408, and a system controller 410. In some embodiments, the dispense heads 404, 406 move independently of one another and independently of the manufacturing support 402 during the polishing pad manufacturing process. Typically, the first and second dispense heads 404 and 406 are fluidly coupled to corresponding first and second pre-polymer composition sources 412 and 414 which provide respective first and second pre-polymer compositions.

In some embodiments, the additive manufacturing system 400 features a third dispense head (not shown) which is fluidly coupled to a sacrificial material precursor source (not shown). In some embodiments, the additive manufacturing system 400 includes as many dispense heads as desired to each dispense a different pre-polymer composition or sacrificial material precursor composition. In some embodiments, the additive manufacturing system 400 further comprises pluralities of dispense heads where two or more dispense heads are configured to dispense the same pre-polymer compositions or sacrificial material precursor compositions.

Here, each of dispense heads 404, 406 features an array of droplet ejecting nozzles 416 configured to eject droplets 430, 432 of the respective pre-polymer compositions delivered to the dispense head reservoirs. Here, the droplets 430, 432 are ejected towards the manufacturing support and thus onto the manufacturing support 402 or onto a previously formed print layer 418 disposed on the manufacturing support 402. Typically, each of dispense heads 404, 406 is configured to fire (control the ejection of) droplets 430, 432 from each of the nozzles 416 in a respective geometric array or pattern independently of the firing other nozzles 416 thereof. Herein, the nozzles 416 are independently fired according to a droplet dispense pattern for a print layer to be formed, such as the print layer 424, as the dispense heads 404, 406 move relative to the manufacturing support 402. Once dispensed, the droplets 430, 432 are typically at least partially cured by exposure to electromagnetic radiation, e.g., UV radiation 426, provided by an electromagnetic radiation source, such as a UV radiation source 408 to form a print layer, such as the partially formed print layer 424.

In some embodiments, the dispensed droplets 430, 432 are exposed to electromagnetic radiation to physically fix the droplet before it spreads to an equilibrium size such as set forth in the description of FIG. 4B. Typically, the dispensed droplets 430, 432 are exposed to electromagnetic radiation to at least partially cure the pre-polymer compositions thereof within 1 second or less of the droplet contacting a surface, such as the surface of the manufacturing support 402 or of a previously formed print layer 418 disposed on the manufacturing support 402. Often, fixing a droplet also desirably fixes the location of dispensed droplet on a surface by preventing the coalescing of the droplet with other droplets disposed adjacent thereto. Further, fixing the dispensed droplets beneficially retards or substantially prevents the diffusion of pre-polymer components across the interfacial regions of adjacently disposed droplets of different pre-polymer compositions. Thus, the intermixing of droplets of different pre-polymer compositions may be desirably controlled to provide relatively distinct material property transitions between different adjacently disposed material domains. For example, in some embodiments one or more transition regions between adjacently disposed different material domains which generally comprise some intermixing of the different precursor compositions have a width (not shown) of less than about 50 μm, such as less than about 40 μm, less than about 30 μm, less than about 20 μm, for example less than about 10 μm.

FIG. 4B is a close up cross-sectional view schematically illustrating a droplet 432 disposed on a surface 418a of a previously formed layer, such as the previously formed layer 418 described in FIG. 4A, according to some embodiments. In a typically additive manufacturing process, a droplet of pre-polymer composition, such as the droplet 432a will spread and reach an equilibrium contact angle α with the surface 418a of a previously formed layer within about one second from the moment in time that the droplet 432a contacts the surface 418a. The equilibrium contact angle α is a function of at least the material properties of the pre-polymer composition and the energy at the surface 418a (surface energy) of the previously formed layer, e.g., previously formed layer 418. In some embodiments, it is desirable to at least the partially cure the dispensed droplet before it reaches an equilibrium size in order to fix the droplets contact angle with the surface 418a of the previously formed layer. In those embodiments, the fixed droplet's 432b contact angle θ is greater than the equilibrium contact angle α of the droplet 432a of the same pre-polymer composition which was allowed to spread to its equilibrium size.

Herein, at least partially curing the dispensed droplets 430, 432 causes the at least partial polymerization, e.g., the cross-linking, of each of the first and second pre-polymer compositions within the droplets and with adjacently disposed droplets of the same pre-polymer composition to form distinct first and second polymer domains respectively, such as the first and second material domains described herein. Further, at least partially curing the first and second pre-polymer compositions causes the at least partial copolymerization of the first and second pre-polymer compositions at the interfacial regions between adjacently disposed droplets of the first and second pre-polymer compositions. At least partial polymerization of the first and second pre-polymer compositions retards or substantially prevents the diffusion of pre-polymer components across the interfacial boundary regions of adjoining droplets of different pre-polymer composition allowing for fine control of intermixing therebetween. In other words, at least partially curing the dispensed droplets 403, 432 causes the at least partial polymerization of the first and second pre-polymer compositions within the droplets, the at least partial co-polymerization of the first and second pre-polymer compositions between adjacently disposed droplets, and the at least partial polymerization or co-polymerization between the droplets 403, 432 and the at the least partially cured material of the previously formed print layer 418 adjacently disposed there below.

In some embodiments, which may be combined with other embodiments described herein, the first and second pre-polymer compositions each comprise a mixture of one or more of functional polymers, functional oligomers, functional monomers, reactive diluents, and photoinitiators.

Examples of suitable functional polymers which may be used to form one or both of the at least two pre-polymer compositions include multifunctional acrylates including di, tri, tetra, and higher functionality acrylates, such as 1,3,5-triacryloylhexahydro-1,3,5-triazine or trimethylolpropane triacrylate.

Examples of suitable functional oligomers which may be used to form one or both of the at least two pre-polymer compositions include monofunctional and multifunctional oligomers, acrylate oligomers, such as aliphatic urethane acrylate oligomers, aliphatic hexafunctional urethane acrylate oligomers, diacrylate, aliphatic hexafunctional acrylate oligomers, multifunctional urethane acrylate oligomers, aliphatic urethane diacrylate oligomers, aliphatic urethane acrylate oligomers, aliphatic polyester urethane diacrylate blends with aliphatic diacrylate oligomers, or combinations thereof, for example bisphenol-A ethoxylate diacrylate or polybutadiene diacrylate, tetrafunctional acrylated polyester oligomers, and aliphatic polyester based urethane diacrylate oligomers.

Examples of suitable monomers which may be used to from one or both of the at least two pre-polymer compositions include both mono-functional monomers and multifunctional monomers. Suitable mono-functional monomers include tetrahydrofurfuryl acrylate (e.g. SR285 from Sartomer®), tetrahydrofurfuryl methacrylate, vinyl caprolactam, isobornyl acrylate, isobornyl methacrylate, 2-phenoxyethyl acrylate, 2-phenoxyethyl methacrylate, 2-(2-ethoxyethoxy)ethyl acrylate, isooctyl acrylate, isodecyl acrylate, isodecyl methacrylate, lauryl acrylate, lauryl methacrylate, stearyl acrylate, stearyl methacrylate, cyclic trimethylolpropane formal acrylate, 2-[[(Butylamino) carbonyl]oxy]ethyl acrylate (e.g. Genomer 1122 from RAHN USA Corporation), 3,3,5-trimethylcyclohexane acrylate, or mono-functional methoxylated PEG (350) acrylate. Suitable multifunctional monomers include diacrylates or dimethacrylates of diols and polyether diols, such as propoxylated neopentyl glycol diacrylate, 1,6-hexanediol diacrylate, 1,6-hexanediol dimethacrylate, 1,3-butylene glycol diacrylate, 1,3-butylene glycol dimethacrylate 1,4-butanediol diacrylate, 1,4-butanediol dimethacrylate, alkoxylated aliphatic diacrylate (e.g., SR9209A from Sartomer®), diethylene glycol diacrylate, diethylene glycol dimethacrylate, dipropylene glycol diacrylate, tripropylene glycol diacrylate, triethylene glycol dimethacrylate, alkoxylated hexanediol diacrylates, or combinations thereof, for example SR562, SR563, SR564 from Sartomer®.

Typically, the reactive diluents used to form one or more of the at least two different pre-polymer compositions are least monofunctional, and undergo polymerization when exposed to free radicals, Lewis acids, and/or electromagnetic radiation. Examples of suitable reactive diluents include monoacrylate, 2-ethylhexyl acrylate, octyldecyl acrylate, cyclic trimethylolpropane formal acrylate, caprolactone acrylate, isobornyl acrylate (IBOA), or alkoxylated lauryl methacrylate.

Examples of suitable photoinitiators used to form one or more of the at least two different pre-polymer compositions include polymeric photoinitiators and/or oligomer photoinitiators, such as benzoin ethers, benzyl ketals, acetyl phenones, alkyl phenones, phosphine oxides, benzophenone compounds and thioxanthone compounds that include an amine synergist, or combinations thereof.

Examples of polishing pad materials formed of the pre-polymer compositions described above typically include at least one of oligomeric and, or, polymeric segments, compounds, or materials selected from the group consisting of: polyamides, polycarbonates, polyesters, polyether ketones, polyethers, polyoxymethylenes, polyether sulfone, polyetherimides, polyimides, polyolefins, polysiloxanes, polysulfones, polyphenylenes, polyphenylene sulfides, polyurethanes, polystyrene, polyacrylonitriles, polyacrylates, polymethylmethacrylates, polyurethane acrylates, polyester acrylates, polyether acrylates, epoxy acrylates, polycarbonates, polyesters, melamines, polysulfones, polyvinyl materials, acrylonitrile butadiene styrene (ABS), halogenated polymers, block copolymers, and random copolymers thereof, and combinations thereof.

Some embodiments described herein further include pore forming features formed of a sacrificial material, e.g., a water soluble material, such as, glycols (e.g., polyethylene glycols), glycol-ethers, and amines. Examples of suitable sacrificial material precursors which may be used to form the pore forming features described herein include ethylene glycol, butanediol, dimer diol, propylene glycol-(1,2) and propylene glycol-(1,3), octane-1,8-diol, neopentyl glycol, cyclohexane dimethanol (1,4-bis-hydroxymethylcyclohexane), 2-methyl-1,3-propane diol, glycerine, trimethylolpropane, hexanediol-(1,6), hexanetriol-(1,2,6) butane triol-(1,2,4), trimethylolethane, pentaerythritol, quinitol, mannitol and sorbitol, methylglycoside, also diethylene glycol, triethylene glycol, tetraethylene glycol, polyethylene glycols, dibutylene glycol, polybutylene glycols, ethylene glycol, ethylene glycol monobutyl ether (EGMBE), diethylene glycol monoethyl ether, ethanolamine, diethanolamine (DEA), triethanolamine (TEA), and combinations thereof.

In some embodiments, the sacrificial material precursor comprises a water soluble polymer, such as 1-vinyl-2-pyrrolidone, vinylimidazole, polyethylene glycol diacrylate, acrylic acid, sodium styrenesulfonate, Hitenol BC10®, Maxemul 6106®, hydroxyethyl acrylate and [2-(methacryloyloxy)ethyltrimethylammonium chloride, 3-allyloxy-2-hydroxy-1-propanesulfonic acid sodium, sodium 4-vinylbenzenesulfonate, [2-(methacryloyloxy)ethyl]dimethyl-(3-sulfopropyl)ammonium hydroxide, 2-acrylamido-2-methyl-1-propanesulfonic acid, vinylphosphonic acid, allyltriphenylphosphonium chloride, (vinylbenzyl)trimethylammonium chloride, allyltriphenylphosphonium chloride, (vinylbenzyl)trimethylammonium chloride, E-SPERSE RS-1618, E-SPERSE RS-1596, methoxy polyethylene glycol monoacrylate, methoxy polyethylene glycol diacrylate, methoxy polyethylene glycol triacrylate, or combinations thereof.

Here, the additive manufacturing system 400 shown in FIG. 4A further includes the system controller 410 to direct the operation thereof. The system controller 410 includes a programmable central processing unit (CPU) 434 which is operable with a memory 435 (e.g., non-volatile memory) and support circuits 436. The support circuits 436 are conventionally coupled to the CPU 434 and comprise cache, clock circuits, input/output subsystems, power supplies, and the like, and combinations thereof coupled to the various components of the additive manufacturing system 400, to facilitate control thereof. The CPU 434 is one of any form of general purpose computer processor used in an industrial setting, such as a programmable logic controller (PLC), for controlling various components and sub-processors of the additive manufacturing system 400. The memory 435, coupled to the CPU 434, is non-transitory and is typically one or more of readily available memories such as random access memory (RAM), read only memory (ROM), floppy disk drive, hard disk, or any other form of digital storage, local or remote.

Typically, the memory 435 is in the form of a computer-readable storage media containing instructions (e.g., non-volatile memory), which when executed by the CPU 434, facilitates the operation of the manufacturing system 400. The instructions in the memory 435 are in the form of a program product such as a program that implements the methods of the present disclosure.

The program code may conform to any one of a number of different programming languages. In one example, the disclosure may be implemented as a program product stored on computer-readable storage media for use with a computer system. The program(s) of the program product define functions of the embodiments (including the methods described herein).

Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the methods described herein, are embodiments of the present disclosure. In some embodiments, the methods set forth herein, or portions thereof, are performed by one or more application specific integrated circuits (ASICs), field-programmable gate arrays (FPGAs), or other types of hardware implementations. In some other embodiments, the polishing pad manufacturing methods set forth herein are performed by a combination of software routines, ASIC(s), FPGAs and, or, other types of hardware implementations.

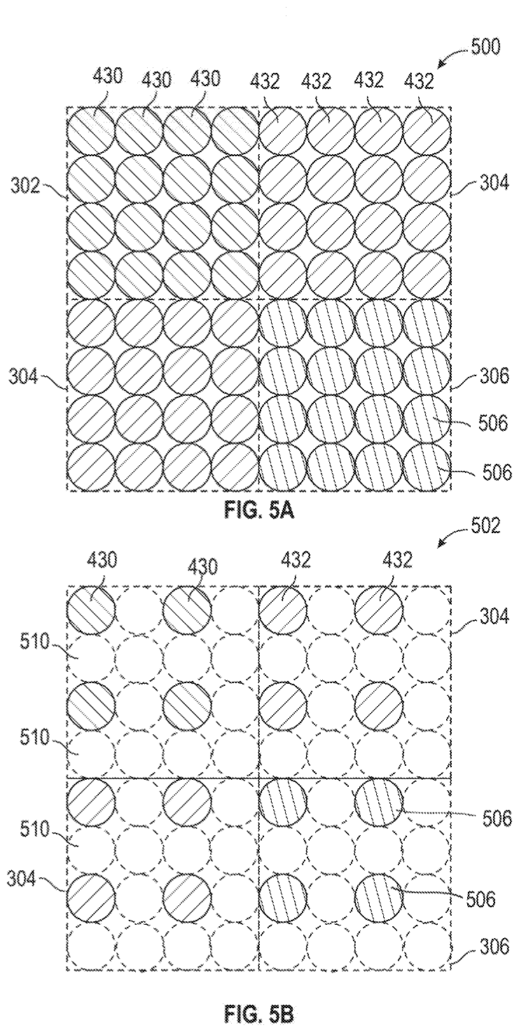

Here, the system controller 410 directs the motion of the manufacturing support 402, the motion of the dispense heads 404 and 406, the firing of the nozzles 416 to eject droplets of pre-polymer compositions therefrom, and the degree and timing of the curing of the dispensed droplets provided by the UV radiation source 408. In some embodiments, the instructions used by the system controller to direct the operation of the manufacturing system 400 include droplet dispense patterns for each of the print layers to be formed. In some embodiments, the droplet dispense patterns are collectively stored in the memory 425 as CAD-compatible digital printing instructions. Examples of print instructions which may be used by the additive manufacturing system 400 to manufacture the polishing pads described herein are schematically represented in FIGS. 5A-5B.

FIGS. 5A and 5B schematically represent portions of CAD compatible print instructions which may be used by the additive manufacturing system 400 to practice the methods set forth herein, according to some embodiments. Here, the print instructions 500 or 502 are used to control the placement of droplets 430, 432 of the pre-polymer compositions which are used to form respective material domains 302, 304 and the droplets 506 of a sacrificial material precursor which are used to form the pore forming features 306. Typically, the placement of the droplets 430, 432, and 506 are controlled by selectively firing one or more of the nozzles of a respective dispense head array of nozzles as the dispense heads of an additive manufacturing system move relative to a manufacturing support. FIG. 5B schematically represents a CAD compatible print instruction where less than all of the nozzles are fired as the dispense heads move relative to the manufacturing support and the space therebetween is shown in phantom as omitted droplets 510.

Typically, the combined volume of the droplets dispensed in a print layer, or a portion of a print layer, determines an average thickness thereof. Thus, the ability to selectively fire less than all of the nozzles within a dispense head array of nozzles allows for fine control over the Z-resolution (average thickness) of a print layer. For example, the print instructions 500 and 502 in FIGS. 5A and 5B may each be used to form one or more respective print layers of a polishing pad on the same additive manufacturing system. If the dispensed droplets are of the same size the combined volume of droplets dispensed using print instructions 502 will be less than the combined volume of droplets dispensed using print instructions 500 and thus will form a thinner print layer. In some embodiments, such as embodiments where less than all of the nozzles are fired as the dispense heads move relative to the manufacturing support, the droplets are allowed to spread to facilitate polymerization or copolymerization with other droplets dispensed proximate thereto and thus ensure substantial coverage of the previously formed print layer.

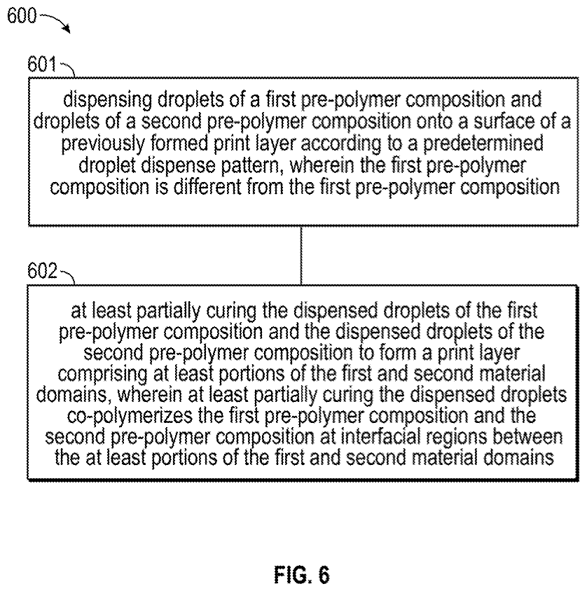

FIG. 6 is a flow diagram setting forth a method of forming a print layer of a polishing pad according to one or more embodiments. Embodiments of the method 600 may be used in combination with one or more of the systems and system operations described herein, such as the additive manufacturing system 400 of FIG. 4A, the fixed droplets of FIG. 4B, and the print instructions of FIGS. 5A-5B. Further, embodiments of the method 600 may be used to form any one or combination of the polishing pads shown and described herein, such as the polishing pads 2A-2B including the embodiments set forth in FIGS. 3A-3D.

At activity 601 the method 600 includes dispensing droplets of a first pre-polymer composition and droplets of a second pre-polymer composition onto a surface of a previously formed print layer according to a predetermined droplet dispense pattern. Here the first pre-polymer composition is different from the second pre-polymer composition. For example, in some embodiments, the first pre-polymer composition includes one or more monomers or oligomers which are different from the monomers or oligomers used to form the second pre-polymer composition.

At activity 602 the method 600 includes at least partially curing the dispensed droplets of the first pre-polymer composition and the dispensed droplets of the second pre-polymer composition to form a print layer comprising at least portions of one or more first material domains and a plurality of second material domains. Here, at least partially curing the dispensed droplets co-polymerizes the first pre-polymer composition and the second pre-polymer composition at interfacial regions between the one or more first material domains and the plurality of second material domains to form a continuous polymer phase of polishing material. In some embodiments, the plurality of second material domains are distributed in a pattern in an X-Y plane parallel to a supporting surface of the polishing pad and are disposed in a side by side arrangement with the one or more first material domains. Typically, the one or more first material domains and the second material domains comprise a difference in one or more material properties from one another.

In some embodiments, the method 600 further includes sequential repetitions of activities 601 and 602 to form a plurality of print layers stacked in a Z-direction, i.e., a direction orthoganal to the surface of the manufacturing support or a previously formed print layer disposed thereon. The predetermined droplet dispense pattern used to form each print layer may be the same or different as a predetermined droplet dispense pattern used to form a previous print layer disposed there below. In some embodiments, the method 600 further includes dispensing droplets of a sacrificial material or a sacrificial material precursor according to a predetermined droplet dispense pattern to form at least portions of a plurality of spatially arranged pore forming features in one or more sequentially formed print layers.

The methods described herein beneficially provide for the manufacturing of polishing pads have controlled and repeatable spatially arranged material domains comprising different material properties therebetween. The ability to spatially arrange material domains within a continuous polymer phase of polishing material allows for the repeatable and controlled ability to manufacture polishing pads desirably comprising more than one material property in the polishing pad material thereof.

While the foregoing is directed to embodiments of the present disclosure, other and further embodiments of the disclosure may be devised without departing from the basic scope thereof, and the scope thereof is determined by the claims that follow.

1. A polishing pad, comprising:
a continuous polymer phase of polishing pad material which forms a polishing surface of the polishing pad, comprising:
one or more first material domains formed of a polymerized reaction product of a first pre-polymer composition; and
a plurality of second material domains formed of a polymerized reaction product of a second pre-polymer composition, wherein
the second pre-polymer composition is different from the first pre-polymer composition,
interfacial regions between the one or more first material domains and the plurality of second material comprise a co-polymerized reaction product of the first pre-polymer composition and the second pre-polymer composition,
the plurality of second material domains are distributed in a pattern in the continuous phase of polymer material, the pattern comprising:
(a) the plurality of second material domains disposed in a side-by-side arrangement with the one or more first material domains in an X-Y plane of the continuous polymer phase of polishing pad material, wherein at least one lateral dimension of one or more of the plurality second material domains is less than about 10 mm when measured in the X-Y plane;
(b) the plurality of second material domains disposed in an alternating stacked arrangement with the one or more first material domains in a Z plane of the continuous polymer phase of polishing pad material, wherein at least one dimension of one or more of the plurality of second material domains is less than about 1 mm when measured in the Z plane; or
c) a combination of (a) and (b),
the X-Y plane is parallel to a supporting surface of the polishing pad,
the Z plane is orthogonal to the X-Y plane, and
the one or more first material domains and the plurality of second material domains comprise a difference in one or more material properties from one another.

2. The polishing pad of claim 1, wherein
the plurality of second material domains are distributed in the side-by-side arrangement with the one or more first material domains, and
at least one dimension of one or more of the plurality of second material domains is less than about 500 μm when measured in the X-Y plane.

3. The polishing pad of claim 1, wherein the one or more material properties are selected from the group consisting of storage modulus E′, loss modulus E″, hardness, tan δ, yield strength, ultimate tensile strength, elongation, thermal conductivity, zeta potential, mass density, surface tension, Poison's ratio, fracture toughness, surface roughness (Rₐ), glass transition temperature (Tg), and combinations thereof.

4. The polishing pad of claim 1, wherein a ratio of storage modulus between the first material domains and the second material domains is more than about 1:2.

5. The polishing pad of claim 1, further comprising a plurality of pore forming features interspersed within the continuous polymer phase of polishing pad material.

6. The polishing pad of claim 1, wherein
the plurality of second material domains are distributed in a pattern in the stacked arrangement with the one or more first material domains, and
at least one dimension of one or more of the second material domains is less than about 1 mm when measured in the Z plane.

7. The polishing pad of claim 1, wherein the continuous polymer phase of polishing material is formed by sequential repetitions of:
dispensing droplets of the first pre-polymer composition and droplets of the second pre-polymer composition onto a surface of a previously formed print layer; and
at least partially curing the dispensed droplets of the first pre-polymer composition and the dispensed droplets of the second pre-polymer composition to form a print layer.

8. The polishing pad of claim 7, further comprising a plurality of pore forming features interspersed within the continuous polymer phase of polishing pad material, wherein one or more of the sequential repetitions used to form the continuous polymer phase of polishing material further includes dispensing droplets of a sacrificial material or a sacrificial material precursor according to a droplet dispense pattern to form at least portions of the plurality of pore forming features.

9. A method of forming a polishing pad, comprising sequential repetitions of:
dispensing droplets of a first pre-polymer composition and droplets of a second pre-polymer composition onto a surface of a previously formed print layer according to a predetermined droplet dispense pattern, wherein the first pre-polymer composition is different from the second pre-polymer composition; and
at least partially curing the dispensed droplets of the first pre-polymer composition and the dispensed droplets of the second pre-polymer composition to form a print layer comprising at least portions of one or more first material domains and a plurality of second material domains, wherein
at least partially curing the dispensed droplets at least partially co-polymerizes the first pre-polymer composition and the second pre-polymer composition at interfacial boundary regions disposed at adjoining locations of the first and second material domains to form a continuous polymer phase of polishing material,
the plurality of second material domains are distributed in a pattern the continuous phase of polymer material, the pattern comprising:
(a) the plurality of second material domains disposed in a side-by-side arrangement with the one or more first material domains in an X-Y plane of the continuous polymer phase of polishing pad material, wherein at least one lateral dimension of one or more of the plurality of second material domains is less than about 10 mm when measured in the X-Y plane;
(b) the plurality of second material domains disposed in an alternating stacked arrangement with the one or more first material domains in a Z plane of the continuous polymer phase of polishing pad material, wherein at least one dimension of one or more of the plurality of second material domains is less than about 1 mm when measured in the Z plane; or
c) a combination of (a) and (b),
the X-Y plane is parallel to the surface of the previously formed print layer,
the Z plane is orthogonal to the X-Y plane, and
the one or more first material domains and the plurality of second material domains comprise a difference in one or more material properties from one another.

10. The method of claim 9, wherein at least one dimension of one or more of the plurality of second material domains is less than about 500 μm when measured in the X-Y plane.

11. The method of claim 9, wherein one or more print layers are formed to have a thickness of less than about 200 μm.

12. The method of claim 9, wherein the one or more material properties are selected from the group consisting of storage modulus E′, loss modulus E″, hardness, tan δ, yield strength, ultimate tensile strength, elongation, thermal conductivity, zeta potential, mass density, surface tension, Poison's ratio, fracture toughness, surface roughness (Rₐ), glass transition temperature (Tg), and combinations thereof.

13. The method of claim 9, wherein a ratio of storage modulus between the second material domains and the first material domains is more than about 1:2.

14. The method of claim 9, wherein one or more of the sequential repetitions used to form the continuous polymer phase of polishing material further comprises dispensing droplets of a sacrificial material or a sacrificial material precursor according to a droplet dispense pattern to form at least portions of a plurality of pore forming features interspersed within the continuous polymer phase of polishing material.

15. The method of claim 9, wherein
the plurality of second material domains are distributed in the stacked arrangement with the one or more first material domains, and
at least one dimension of one or more of the plurality of second material domains is less than about 1 mm when measured in the Z plane.

16. An additive manufacturing system comprising a computer readable medium having instructions stored thereon for performing a method of manufacturing a polishing pad when executed by a system controller, the method comprising sequential repetitions of:
dispensing droplets of a first pre-polymer composition and droplets of a second pre-polymer composition which is different from the first pre-polymer composition onto a surface of a previously formed print layer according to a predetermined droplet dispense pattern; and
at least partially curing the dispensed droplets of the first pre-polymer composition and the dispensed droplets of the second pre-polymer composition to form a print layer comprising at least portions of one or more first material domains and a plurality of second material domains, wherein
at least partially curing the dispensed droplets at least partially co-polymerizes the first pre-polymer composition and the second pre-polymer composition at interfacial boundary regions disposed at adjoining locations of the first and second material domains to form a continuous polymer phase of polishing material,
the plurality of second material domains are distributed in a pattern, the pattern comprising:
(a) the plurality of second material domains disposed in a side-by-side arrangement with the one or more first material domains in an X-Y plane of the continuous polymer phase of polishing pad material, wherein at least one lateral dimension of one or more of the plurality of second material domains is less than about 10 mm when measured in the X-Y plane;
(b) the plurality of second material domains disposed in an alternating stacked arrangement with the one or more first material domains in a Z plane of the continuous polymer phase of polishing pad material, wherein at least one dimension of one or more of the plurality of second material domains is less than about 1 mm when measured in the Z plane; or
c) a combination of (a) and (b),
the X-Y plane is parallel to the surface of the previously formed print layer,
the Z plane is orthogonal to the X-Y plane, and
the one or more first material domains and the plurality of second material domains comprise a difference in one or more material properties from one another.

17. The additive manufacturing system of claim 16, wherein least one dimension of one or more of the plurality of second material domains is less than about 500 μm when measured in the X-Y plane.

18. The additive manufacturing system of claim 16, wherein one or more print layers are formed to have a thickness of less than about 200 μm.

19. The additive manufacturing system of claim 16, wherein one or more of the sequential repetitions further comprises dispensing droplets of a sacrificial material or a sacrificial material precursor according to a droplet dispense pattern to form at least portions of a plurality of pore forming features interspersed within the continuous polymer phase of polishing material.

20. The additive manufacturing system of claim 16, wherein
the plurality of second material domains are distributed in the stacked arrangement with the one or more first material domains,
at least one dimension of one or more of the plurality of second material domains is less than about 1 mm when measured in the Z plane.
